(19) United States
(12) Patent Application Publication
(10) Pub. No.: US 2024/0335881 A1
(43) Pub. Date: Oct. 10, 2024

(54) METHODS FOR 3D PRINTING AND ADDITIVE MANUFACTURING OF REFRACTORY ALLOYS

(71) Applicants: CASTHEON INC, THOUSAND OAKS, CA (US); Addman Intermediate Holdings, LLC, Fort Myers, FL (US)

(72) Inventor: Youping Gao, Thousand Oaks, CA (US)

(73) Assignee: Addman Intermediate Holdingd, LLC, Fort Myers, FL (US)

(21) Appl. No.: 18/239,366

(22) PCT Filed: May 25, 2022
(86) PCT No.: PCT/US2022/072574

§ 371 Date: Aug. 29, 2023

Related U.S. Application Data
(60) Provisional application No. 63/192,848, filed on May 25, 2021.

(51) Int. Cl. B22F 10/60; B33Y 10/00; B33Y 40/20; B33Y 70/00; C22C 1/04; C23C 24/08; C23C 28/02

(52) U.S. Cl. CPC B22F 10/60; C22C 1/045; C23C 24/08; C23C 28/021; B22F 2998/10; B22F 2999/00; B33Y 10/00; B33Y 40/20; B33Y 70/00

(57) ABSTRACT

A part made from a refractory alloy is manufactured using additive manufacturing or casting. The part is coated with a protective coating prior to the step of hot isostatic pressing the part.

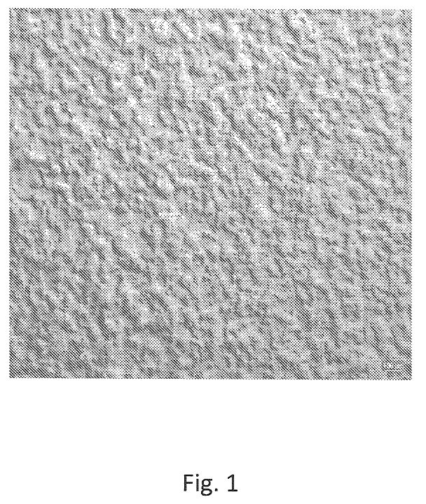

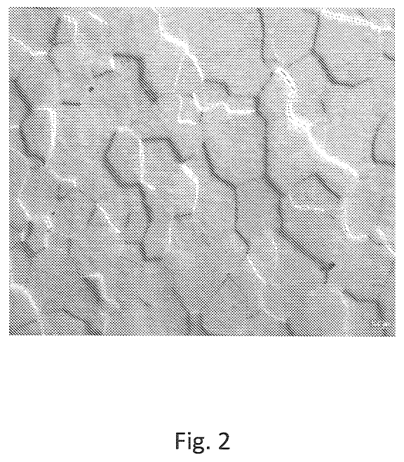

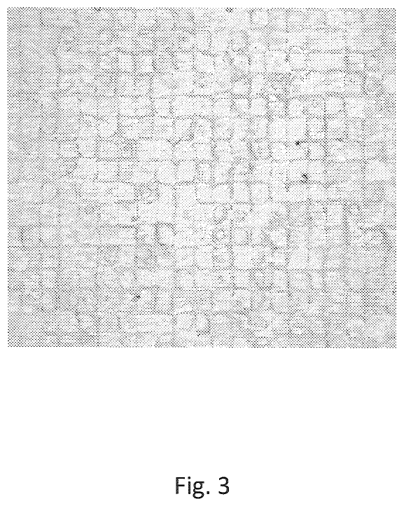

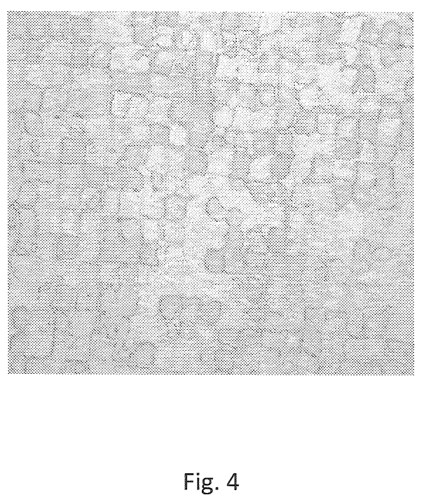

### CROSS REFERENCE TO RELATED APPLICATIONS

This application is a continuation-in-part application of co-pending PCT Application PCT/US22/725784 which, in turn, is a completion application of U.S. Provisional Patent Application Ser. No. 63/192,848 filed on May 25, 2021, the disclosures of which are hereby incorporated by reference in their entirety.

### FIELD

The present invention generally relates to processes for additive manufacturing or casting of refractory alloys.

### BACKGROUND

In general, refractory alloys are mostly solid solution strengthened (substitutional strengthened) and are very sensitive to contamination from interstitial elements such as oxygen, nitrogen and carbon, to name a few. The most popular refractory alloy in the aerospace industry is Niobium Alloy C103 (Nb-10Hf-1Ti). Other refractory alloys include but are not limited to Niobium (Nb), Rhenium (Re), Tantalum (Ta), Molybdenum (Mo) and Tungsten (W) to name a few.

Refractory metals are a class of metals that are extraordinarily resistant to heat and wear. Their melting temperature are above 2400° C./4400° F., double that of a superalloy. The high melting temperature of refractory metals is extremely desirable for extreme high temperature applications, such as rocket engine, advanced turbine, missile, and hypersonic.

In general, refractory alloys are very sensitive to interstitial elements contamination (oxygen, nitrogen, carbon). For example, the most popular refractory alloy in the aerospace industry, the Niobium Alloy C103 (Nb-10Hf-1Ti), and other refractory alloys such as W—Re, Mo—Re, Ta—W may be easily contaminated. When interstitial elements concentrations are above containing limits (such as O₂:350 ppm and N₂:100 ppm), the refractory alloys properties degrade significantly. When contaminated, the alloys may exhibit undesirable characteristics such as embrittlement and/or loss of ductility (null ductility) which will literally render the material useless. The main reason for contamination and thus, degradation is: 1.) the interstitial elements didn't form stable oxides and/or nitrides; 2.) the interstitial elements are not in the size range where cohesive strengthening can be provided; 3.) the interstitial elements are not distributed evenly and instead are laced in the grain boundary, which weakens the overall material properties. So typical, refractory alloys have very tight, not to exceed, interstitial contents in the wrought form.

Additive manufacturing is a rapidly growing industry and there is a need to be able to create stronger materials and alloys that can be used with the additive manufacturing process. Additive manufacturing or casting provide great shaping capability but also may leave defects or voids in the materials that need to be closed i.e. eliminated through Hot Isostatic Press (HIP). To this end, there is a great need to figure out methods and processes to create parts that is free from defects or minimize the amount of defects

### SUMMARY OF THE INVENTION

Objects of the present patent document are to provide improved methods of manufacturing parts from refractory alloys using additive manufacturing or casting. In preferred embodiments, the method comprises manufacturing a part made from a refractory alloy using additive manufacturing or casting. The part is then coated with a protective coating prior to the step of hot isostatic pressing the part. The protective coating is preferably a surface coating that is meant to be permanent part of the final product.

In preferred embodiments, the protective coating is selected from the group consisting of slurry coating, Chemical Vapor Deposition coating, Physical Vapor Deposition coating and EL coating.

In preferred embodiments, the refractory alloy is selected from the group consisting of Niobium Alloy C103 (Nb-10Hf-1Ti), Niobium (Nb), Rhenium (Re), Tantalum (Ta), Molybdenum (Mo) and Tungsten (W).

In some embodiments, additional steps may be part of the process. In some embodiments, one or more interfaces on the part are machined prior to the coating step.

Optionally, the part is annealed prior to the coating step.

### DETAILED DESCRIPTION OF THE PREFERRED EMBODIMENTS

For the traditional wrought alloy, the standard manufacturing process has the following steps:
Forged stock material
rough machining
finish machining
anneal (optional)
slurry coating, Chemical Vapor Deposition (CVD) coating, Physical Vapor Deposition (PVD) coating, EL coating
functional integration

For the 3D printed (additive manufacturing, selective laser sintering, and similar processes) or casting refractory alloy, the standard manufacturing process has the following steps in this exact order:
3D printing
Hot Isostatic Press (HIP)
Finish machining
Anneal (optional)
slurry coating, CVD coating, PVD coating, EL coating
functional integration

Since 3D printed or casted hardware may contain small and distributed flaws (discontinuities, voids, holes, and cracks) that HIP densification is often used to heal the flaws to enhance the materials properties of the part, particularly for mission critical applications. Traditionally, this step is always done immediately after 3D printing the part.

However, for the reactive refractory alloys, the HIP step is often the source of interstitial contamination that can destroy the material properties of a perfectly good part/product. The refractory alloys are so reactive at elevated temperature that not only a very clean HIP furnace is required to process them but they also required to be wrap with sacrificial foil materials such as Ta foil to protect them from furnace cycle contamination.

To this end, the Applicant has discovered a new process that prevents the HIP from degrading the properties of a refractory alloy. The new process moves the HIP step down in the process until after the coating process is applied. The new process takes advantage of the coating step to protect the refractory materials in the application stage and moves it into processing stage to protect the refractory materials from contamination during HIP. This can be done without degrading the coating function or materials properties.

This new process prevents the HIP step from degrading the refractory alloy through contamination. One embodiment of the new process is:
3D printing or casting
machining interface
anneal (optional)
slurry coating, CVD coating, PVD coating, EL coating
Hot Isostatic Press (HIP)
(optional finish machining)
functional integration

The new process above, eliminates HIP contamination. The application of the coating prior to the HIP step protects the reactive refractory materials from interstitial attack at elevated temperatures including those found during HIP. Numerous suppliers known in the art supply protective coatings including independent companies such as Hitemco (NY) or Bodycote (CA) or Thermal Vac (CA). In other embodiments, the coating may be in house processed. The key is that the HIP step comes after the coating step and not before it.

As used herein, the term “protective coating” refers to a coating the is permanently applied to the part, not something that is removeable such as foil or other wraps.

It would not be obvious for one skilled in the art to move the coating step before the HIP step because the coating step is a finishing step. It would also not be obvious because HIP uses very high temperature and pressures and changes the material properties of the part and it would accordingly, be expected to damage or at least affect the material properties of the coating. It is also not obvious how the adhesion of the coating to the part would be affected by the HIP process.

The coating which is applied to the part is applied by any suitable method, including, for example, immersion, spray coating, and the like. The process hereof is particularly applicable to high temperature refractory alloys including, for example, Nb C103, niobium, rhenium, tantalum, molybdenum and tungsten alloys.

Preferably, in practicing the present invention, a slurry coating is applied. Suitable slurry coatings include, for example, a disilicide. Typically, the coating is applied at a temperature of about 2600° F. It should be noted that, although slurry coating is preferred, chemical vapor deposition and physical vapor deposition, along with electrostatic coating may be used herein. The disilicide slurry coating is particularly useful in connection with the manufacture of an Nb C103 part. The preferred protective coating is a nickel cobalt coating.

Moreover, there is a long felt need for this invention. To applicant's knowledge, the HIP step has always been performed prior to the coating step. Moreover, the industry itself has proven that coating the part prior to the HIP process is not obvious because of all the other solutions currently in use. These other solutions are often time consuming and expensive and thus, if coating first was obvious, it would have already been done. For example, when parts are made of refractory alloys, increased costs are incurred due to the requirement of a super clean HIP furnace. Extensive time and effort have been dedicated by the industry to try and keep the HIP process as clean as possible to prevent contamination. In addition, in the traditional process parts made from a refractory alloy are wrapped with sacrificial foil materials such as Ta foil to protect them from furnace cycle contamination.

The teachings herein, eliminate or greatly reduce the need for a cleaner HIP process and other solutions such as foil wrapping the part. In addition, the results of the processes taught herein are superior and more consistent than simply trying to keep the HIP process clean and or fail wrapping the part.

Having, thus, described the invention, what is claimed is:

1. A method of manufacturing a refractory alloy part comprising:
manufacturing the part using additive manufacturing or casting wherein the part is made from a refractory alloy; and
coating the part with a protective coating prior to the step of hot isostatic pressing the part.

2. The method of claim 1, wherein the protective coating is selected from the group consisting of a slurry coating, a Chemical Vapor Deposition coating, a Physical Vapor Deposition coating and an EL coating.

3. The method of claim 2, wherein the refractory alloy is selected from the group consisting of Niobium Alloy C103 (Nb-10Hf-1Ti), Niobium (Nb) alloy, Rhenium (Re) alloy, Tantalum (Ta) alloy, Molybdenum (Mo) alloy and Tungsten (W) alloy.

4. The method of claim 3 further comprising machining an interface on the part prior to the coating step.

5. The method of claim 4, further comprising annealing the part prior to the coating step.

6. The method of claim 1, comprising manufacturing the part.

7. A method of manufacturing a refractory alloy part comprising:
additive manufacturing the part, wherein the alloy is selected from a group consisting of Niobium Alloy C103 (Nb-10Hf-1Ti), Niobium (Nb) alloy, Rhenium (Re) alloy, Tantalum (Ta) alloy, Molybdenum (Mo) alloy and Tungsten (W) alloy; and
coating the part with a protective coating prior to the step of hot isostatic pressing the part.

8. The method of claim 7, wherein the protective coating is selected from the group consisting of a slurry coating, a Chemical Vapor Deposition coating, a Physical Vapor Deposition coating and an EL coating.

9. The method of claim 8, further comprising machining an interface on the part prior to the coating step.

10. The method of claim 9, further comprising annealing the part prior to the coating step.

11. A method of manufacturing a refractory alloy part comprising:
manufacturing a part using additive manufacturing wherein the part is made from a refractory alloy selected from the group consisting of Niobium Alloy C103 (Nb-10Hf-1Ti), Niobium (Nb) alloy, Rhenium (Re) alloy, Tantalum (Ta) alloy, Molybdenum (Mo) alloy and Tungsten (W) alloy; and
coating the part with a protective coating prior to the step of hot isostatic pressing the part and wherein the protective coating is selected from the group consisting of a slurry coating, a Chemical Vapor Deposition coating, a Physical Vapor Deposition coating and an EL coating.

12. The method of claim 11, further comprising:
machining an interface on the part prior to the coating step.

13. The method of claim 12, further comprising:
annealing the part prior to the coating step.

14. The method of claim 2, wherein the protective coating is a slurry coating.

15. The method of claim 14, wherein the slurry coating is a disilicide coating.

16. The method of claim 15, wherein the slurry coating is applied by either immersion or spraying.

17. The method of claim 16, wherein the part is a Nb C103 part.

18. The method of claim 17, wherein the coating is a nickel cobalt coating.
